(19) United States
(12) Patent Application Publication
(10) Pub. No.: US 2009/0295595 A1
(43) Pub. Date: Dec. 3, 2009

(54) METHOD FOR CONTROL OF A DEVICE

(75) Inventors: Eric Thelen, Aachen (DE); Jan Baptist Adrianus Maria Horsten, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,453

(22) PCT Filed: Aug. 5, 2005
(86) PCT No.: PCT/IB05/52616

§ 371 Date: Jul. 30, 2009

(30) Foreign Application Priority Data
Aug. 12, 2004 (EP) 04103900.9

(51) Int. Cl. G08C 19/00; G09G 5/00

(52) U.S. Cl. 340/825.71; 345/156

(57) ABSTRACT

The invention describes a method for control of a device (D₁, D₂, D₃), which method comprises the process steps of aiming a pointing device (1) comprising a camera (2) at an object associated with the device (D₁, D₂, D₃) to be controlled to choose an option and generating an image (3) of a target area (A) aimed at by the pointing device (1). The target area image (3) is interpreted to determine the chosen option, and a corresponding control signal (17) is generated for controlling the device (D₁, D₂, D₃) to be controlled. Device descriptive information (I_{D1}, I_{D2}, I_{D3}) associated with the device (D₁, D₂, D₃) to be controlled is thereby detected before or during this process, and the process steps are carried out according to the device descriptive information (I_{D1}, I_{D2}, I_{D3}). The invention also describes a system (15) suitable for applying this method as well as a pointing device (1) and a device control interface (8, 8′) for such a system (15).

This invention relates to a method for control of a device, and to a pointing device and device control interface for interacting with a device to be controlled.

The use of pointers, such as laser pointers or “wands” incorporating a laser light source to cause a light point to appear on a target at which the pointer is aimed, has become widespread in recent years. Such pointers are essentially passive devices, since they can only be used to point at objects, typically for pointing out items on a screen or projection to members of an audience. However, their use is limited to such situations, and they cannot be used, for example, to directly control a device.

For control of a device, such as any consumer electronics device, e.g. television, DVD player, tuner, etc., a remote control is generally used. However, in the average household, multiple remote controls can be required, often one for each consumer electronics device. Even for a person well acquainted with the consumer electronics devices he owns, it is a challenge to remember what each button on each remote control is actually for. Furthermore, the on-screen menu-driven navigation available for some consumer electronics devices is often less than intuitive, particularly for users that might not possess an in-depth knowledge of the options available for the device. The result is that the user must continually examine the menu presented on the screen to locate the option he is looking for, and then look down at the remote control to search for the appropriate button. Quite often the buttons are given non-intuitive names or abbreviations. Additionally, a button on the remote control might also perform a further function, which is accessed by first pressing a mode button.

In an effort to reduce the confusion caused by such a multitude of remote controls, a new product category of “universal remote controls” has been developed. However, even a universal remote control cannot hope to access all the functions offered by every consumer electronics device available on the market today, particularly since new technologies and features are continually being developed. Furthermore, the wide variety of functions offered by modern consumer electronics devices necessitates a correspondingly large number of buttons to invoke these functions, requiring an inconveniently large remote control to accommodate all the buttons. Even these so-called universal remote controls are limited to use with certain types of device, typically. consumer electronics devices, and cannot be used to control other types of devices. Furthermore, a remote control is limited to use within range of the devices to be controlled. If the user takes the remote control out of reach of the devices, he can no longer control the function of those devices, and the remote control is effectively of no use to him.

Therefore, an object of the present invention is to provide a more convenient and more flexibly applicable method of controlling any electronically or electrically controllable device, regardless of the environment in which the device is found, and without requiring a user to be familiar with the device.

To this end, the present invention provides a method for control of a device, which method comprises the process steps of aiming a pointing device comprising a camera at an object associated with the device to be controlled to choose an option, generating an image of a target area aimed at by the pointing device, interpreting the target area image to determine the chosen option and generating a corresponding control signal for controlling the device to be controlled. A device descriptive information associated with the device to be controlled is thereby detected before or during this process, and the process steps are carried out according to the device descriptive information.

The ‘device descriptive information’ can merely report the presence of a device. In another embodiment it may also inform the pointing device of any functions that the device can perform. The device descriptive information might even include a set of commands for carrying out these functions, already encoded in a form understandable by the device.

Furthermore, the device descriptive information may influence, in a number of possible ways, the extent to which the steps of the method are carried out. For example, the pointing device might remain essentially inert until it is activated by device descriptive information received from a device or object in the vicinity. It is conceivable that the device descriptive information might also control the function of the camera in some way, so that device descriptive information for one type of device causes the camera of the pointing device to make high-resolution images, whereas another type of device might signal, by its device descriptive information, that low-resolution images are sufficient. The device descriptive information of a device might also describe the type of options available for this device, and might also supply a summary of the commands available for this device. The device descriptive information might also be used, at any stage, to interrupt steps of image or control signal generation already in progress.

The method according to the invention opens whole new applications for a pointing device. Such a pointing device is a particularly universal control tool, since one only has to point at a device or object for a control signal to be generated on the basis of the images generated. In particular, by receiving device descriptive information broadcast by a device to be controlled, a user can easily locate any device—in any environment—and interact with the device using such a pointing device, without first having to make himself familiar with the devices that are available in the vicinity. This capability of the pointing device, together with its convenient pointing modality, as described above, combine to make the present invention a powerful and practical tool for myriad situations in everyday life.

A system for controlling a device comprises a pointing device with a camera for generating images of a target area in the direction in which the pointing device is aimed, so that the images include the device itself or an object associated with the device to be controlled. Also, the system comprises a receiving unit for detecting device descriptive information broadcast by the device to be controlled, an image analysis unit for analysing the images, a control signal generation unit for generating a control signal for the device to be controlled according to the results of the image analysis, and an application interface for communicating the control signal to the device to be controlled. The system is composed in such a manner that the image generation and/or image analysis and/or image transfer and/or control signal generation are carried out according to the device descriptive information of the device to be controlled.

A preferred pointing device for controlling a device comprises—in addition to a camera for generating images of a target area in the direction in which the pointing device is aimed—a receiving unit for detecting device descriptive information from the device to be controlled.

For applying the method using such a pointing device, a device control interface is used, which interacts with the device to be controlled. Such a device control interface comprises at least the image analysis unit for analysing the images, the control signal generation unit for generating a control signal for the device to be controlled, and the application interface for communicating the control signals to the device to be controlled. As will be explained later, such a device control interface can be incorporated in the pointing device or can be realised as an external unit, coupled with the pointing device by means of a suitable communication interface. It may also be incorporated in the device to be controlled.

The functions such as image analysis, control signal generation etc., or the units or modules that carry out these functions, can be distributed as necessary or as desired over the constituent modules of the system mentioned above, i.e. pointing device, device control interface, and device to be controlled.

The dependent claims and the subsequent description disclose particularly advantageous embodiments and features of the invention.

The object at which a user might aim the pointing device can be a device, such as a consumer electronics device, household appliance, or any type of electrically or electronically controllable device in any environment, such as a vending machine, automatic ticket dispenser, etc. Equally, the object can be any type of article or item which is in some way associated with such an electrically or electronically controllable device, for example, the object might be an exhibit in a gallery, where the actual device to be controlled might be a narrative or tutorial system located centrally, and at a distance from the exhibit itself. The ease of use of the pointing device allows the user to aim it directly at the object of interest, without having to be concerned about the actual whereabouts of the device associated with this object. For the sake of simplicity, a device to be controlled might also, where appropriate, be referred to in the following simply as an object.

An object can broadcast its presence to any pointing devices in the vicinity by means of device descriptive information, which might be broadcast as an identification tag, intermittently or at regular intervals, by an identification module associated with the object In a particularly preferred embodiment of the invention, the identification tag is broadcast at radio frequency. The identification module does not necessarily have to be incorporated in the object or device to be controlled, and may in fact be located at a distance away from the actual object or device, since broadcasting the presence or availability of an object can be independent of the actual location of the object. In such a case, it might suffice for the identification module to be positioned in a convenient location. In some cases, it might be particularly convenient to have a number of such identification modules broadcasting the presence of a device, for example, if the device is located centrally and a number of its associated objects are distributed over a wider area. Furthermore, each of a number of objects can be associated with individual identification modules.

In addition to device descriptive information being broadcast from an identification module and picked up by a pointing device, the pointing device can also broadcast its own user identification information for detection by the device associated with the object. Such user identification information might be some kind of code ‘hardwired’ into the pointing device and identifying this particular pointing device, similar to a serial number. Such a user identifier might be desirable for a situation in which only a certain set of pointing devices are permitted to interact with a particular device, for example, only pointing devices issued to employees in a particular building.

Alternatively or in addition, the user identification information might be some kind of identification of the actual user of the device, such as a password, a personal identification number (PIN), or some kind of biometric data, for example a thumbprint or iris descriptive information. This type of identification might be useful in a situation where only certain persons are permitted to operate or interact with a device. One example might be a television, “out of bounds” for children after a certain time; or a security system in a research laboratory, only accessible to certain persons. The user identification information might be hardwired in the pointing device, or might be entered by the user in some way, for example by means of a suitable input modality such as a keypad. Another way of specifying user identification information for the pointing device might be by programming it with the aid of a suitable interface, similar to known methods of programming a remote control.

Similarly, the user identification information for the pointing device may be broadcast as an identification tag by an identification module incorporated in some way in or on the pointing device. The identification tag for the pointing device is also preferably broadcast at radio frequency. Depending on the type of device being controlled and the level of security required when it is being controlled by means of a pointing device, the device descriptive information and/or user identification information might be broadcast in an encrypted form.

Furthermore, identification tags might only be broadcast on request, i.e. if the device to be controlled detects user identification information broadcast from the pointing device of a user who wishes to scan the surroundings to see if there are any controllable devices in the vicinity, it responds by broadcasting device descriptive information. Equally, the pointing device might only send user identification information after it has detected device descriptive information broadcast from a device in the vicinity.

To assist a device in deciding whether a pointing device is to be permitted to control it, the device might compare the user identification information to authorization information, such as a list of permitted user identifiers. If the user identification information is found in the authorization list, the device can conclude that the pointing device from which the user identification information originates has permission to control the device. The list of user identifiers can be stored in a local memory in the device, or might be obtained from an external source such as a PC, a memory stick, the internet, etc. The authorization information might equally well be a list of prohibited user identifiers, for pointing devices that are explicitly forbidden from interacting with the device. The authorization information can be of the same form as the user identifier, such as a password, serial number, part of a code, biometric data etc. The list of authorized or prohibited users or pointing devices might be updated on a regular basis, or as required.

Since a user of a pointing device might use the pointing device in unfamiliar environments where he is not necessarily familiar with the available devices, the proximity of a device controllable by such a pointing device is preferably reported or shown to the user by some kind of feedback indicator.

An object might feature a feedback indicator, which is activated whenever the device to be controlled detects user identification information being broadcast by a pointing device present in the vicinity. Alternatively or in addition, the pointing device might feature a feedback indicator, which is activated when device descriptive information is detected by the pointing device.

Such a feedback indicator might be, for example, a flashing LED, or it might be an audible sound emitted by a loudspeaker. Another way of visually providing feedback might be in the form of a small compass on the pointing device, in which an arrow rotates to show the user the direction in which the object is located. Equally, feedback can be given to the user in a tactile manner, for example by causing the pointing device to vibrate in the user's hand. A combination of indicators might be used, for example a vibration of the pointing device to indicate that an object is in the vicinity, and a flashing LED near the object to attract the user's attention in the right direction.

The camera for generating images of the object is preferably incorporated in the pointing device but might equally be mounted on the pointing device, and is preferably oriented in such a way that it generates images of the area in front of the pointing device targeted by the user. The camera might be constructed in a basic manner, or it might feature powerful functions such as zoom capability or certain types of filter.

Therefore, the ‘target area’ is the area in front of the pointing device, which can be captured as an image by the camera. The image of the target area—or target area image—might cover only a small subset of the object aimed at, or it might encompass the entire object, or it might also include an area surrounding the object. The size of the target area image in relation to the entire object might depend on the size of the object, the distance between the pointing device and the object, and on the capabilities of the camera itself. The user might be positioned so that the pointing device is at some distance from the object, for example when the user is standing at the other end of the room. Equally, the user might hold the pointing device quite close to the object in order to obtain a more detailed image.

The pointing device might feature a control input to allow the user to specify a certain action or actions. Such a control input might be a button that the user can press to indicate that an action is to be carried out. A manipulation of the control input might be encoded into an appropriate signal and transferred, along with the images from the camera, to the device control interface, where the control input signal is interpreted with the images when generating the control signal for the device. For example, the user might aim the pointing device at a particular part of the object representing a particular function, such as an item in a list of menu items, and simultaneously press the control input to indicate that this item is the chosen one.

To assist the user in accurately aiming the pointing device, a source of a concentrated beam of light might be mounted in or on the pointing device and directed so that the ensuing point of light appears more or less in the centre of the target area that can be captured by the camera. The source of a concentrated beam of light might be a laser light source, such as those used in many types of laser pointers currently available. In the following, it is therefore assumed that the source of a concentrated beam of light is a laser light source, without limiting the scope of the invention in any way.

To easily determine the object at which the user is aiming the pointing device, the image analysis unit of the device control interface preferably compares the image of the target area to a number of pre-defined templates, by applying the usual image processing techniques or computer vision algorithms. A single pre-defined template might suffice for the comparison, or it may be necessary to compare the image data to more than one template.

Pre-defined templates can be stored in an internal memory of the device control interface, or might equally be accessed from an external source. Preferably, the device control interface comprises an accessing unit with an appropriate interface for obtaining pre-defined templates for the objects from, for example, an internal or external memory, a memory stick, an intranet or the internet. In this way, a manufacturer of an appliance, which can be controlled by a pointing device according to the invention, can make templates for these appliances available to users of the devices. A template can be a graphic representation of any kind of object. If the objects are options of a menu displayed, for example on a television screen, a template might show the positions of a number of menu options for the television, so that, by analysing image data of the target area when the user aims the pointing device at the television, the image analysis unit can determine which option is being aimed at by the user.

Preferably, a device control interface for interacting with the device(s) to be controlled might be incorporated in the pointing device. In this case, the device control interface obtains the images directly from the camera. The image analysis and control signal generation can take place in the pointing device, and the control signals can be transmitted in appropriate form from the pointing device directly to the device to be controlled.

On the other hand, since the capabilities of these units might be limited by the physical dimensions of the pointing device, which is preferably realised to be held comfortably in the hand, such an image analysis unit might suffice for rudimentary image analysis only, while more advanced image processing, necessitating a larger unit, might, along with the control signal generation, take place in an external device control interface.

In a particularly preferred embodiment of the invention, the pointing device incorporates a device control interface as well as a transmitter for transmitting images and, optionally, device descriptive information to an external device control interface. To receive information from the pointing device, the external device control interface features a receiving unit for receiving images and, optionally, device descriptive information.

Alternatively, the pointing device might altogether dispense with image analysis and control signal generation functions, allowing these tasks to be carried out by the external device control interface, thereby allowing the pointing device to be realised in a smaller, more compact form.

An external device control interface as described above might be a stand-alone device or might be incorporated into an already existing home entertainment device, a personal computer, or might be realised as a dedicated device control interface. A device control interface in a home or office environment, public place, museum etc., might be realised so that the image processing and control signal generation take place centrally, whilst a number of receiving units, distributed about that environment, can receive image data from any number of locations. Equally, a number of application interfaces, also distributed about that environment, can transmit control signals to the devices or appliances located in any room. Thus, the user can aim the pointing device at an object in one room to control a device located in a different room.

Clearly, the device control interface is not limited to use with a single pointing device. Any number of pointing devices might be used to interact with a device control interface. For example, in a home environment, each member of a family might have a personal pointing device, each broadcasting its own user identification information. In a public environment, such as an office building or hospital, employees might be issued with a personal pointing device, broadcasting specific user identification information for that particular environment. In a museum or gallery, each visitor might be issued with a pointing device, which might be programmed with user-specific information such as the user's preferred language for tutorial information. Equally, a visitor might simply bring his own pointing device along and use that instead.

To maximise the usefulness of the pointing device and the device control interface, the device control interface might be trained to recognise objects and to associate them with particular devices to be controlled. To this end, the device control interface might feature an interface such as keyboard or keypad so that information regarding the template images or device control parameters can be specified.

The image of the target area might comprise image data concerning only significant points of the entire image, e.g. enhanced contours, corners, edges etc., or might be a detailed image with picture quality. For processing the image data in order to determine the object at which the user is aiming the pointing device, it is expedient to apply computer vision techniques to find a point in the object at which the user has aimed, i.e. the target point.

Since the image of the target area might contain other items or objects besides the actual object at which the user is aiming the pointing device, the chosen object is preferably determined by identifying the object in the image, which contains or encompasses a particular target point in the target area. In one embodiment of the invention, a fixed point in the target area image, preferably the centre of the target area image, obtained by extending an imaginary line in the direction of the longitudinal axis of the pointing device to the object, might be used as the target point.

A method of processing the target area images of the object using computer vision algorithms might comprise detecting distinctive points in the target image, determining corresponding points in the template of the object, and developing a transformation for mapping the points in the target image to the corresponding points in the template. The distinctive points of the target area image might be distinctive points of the object or might equally be points in the area surrounding the object. This transformation can then be used to determine the position and aspect of the pointing device relative to the object so that the intersection point of an axis of the pointing device with the object can be located in the template. The position of this intersection in the template corresponds to the target point on the object and can be used to easily determine which object has been targeted by the user. In this way, comparing the target area image with the pre-defined template may be restricted to identifying and comparing only salient points such as distinctive corner points. The term “comparing”, as applicable in this invention, is to be understood in a broad sense, i.e. by only comparing sufficient features in order to quickly identify the object at which the user is aiming.

Another possible way of determining an object selected by the user is to directly compare the received target area image, centred around the target point, with a pre-defined template to locate the point targeted in the object using methods such as pattern-matching.

In a further embodiment of the invention, the location of the laser point, fixed at a certain position in the target area and transmitted to the receiver in the control unit as part of the target area image, might be used as the target point to locate the object selected by the user. The laser point, which appears when the beam of laser light impinges on the object aimed at by the use, may coincide with the centre of the target area image, but might equally well be offset from the centre of the target area image.

The invention thus provides, in all, an easy and flexible way to interact with any type of electrically or electronically controllable device in any environment. For ease of use, the pointing device can be in the shape of a wand or pen in an elongated form that can be grasped comfortably by the user and easily carried around by the user. The user can thus direct the pointing device at an object while positioned at a distance from it. Equally, the pointing device might be shaped in the form of a pistol. Furthermore, an additional light source might be mounted in or on the pointing device, serving to illuminate the area at which the pointing device is aimed, so that the user can easily locate an object, even if the surroundings are dark.

The pointing device and device control interface described in the above combine to give a powerful control system, for use in practically any kind of environment. For instance, it is conceivable that the system might find use in any environment featuring devices that can be interacted with by means of a pointing device, such as an office, museum, hospital or hotel environment, to name but a few, where a user can use the pointing device to control unfamiliar devices in a convenient and intuitive manner, without first having to familiarise himself with the functionality of the device. The method according to the invention can be applied to any electrically or electronically controllable device. Furthermore, the device to be controlled and any objects associated with the device can comprise any number of modules, components or units, and can be distributed in any manner.

Other objects and features of the present invention will become apparent from the following detailed descriptions considered in conjunction with the accompanying drawing. It is to be understood, however, that the drawings are designed solely for the purposes of illustration and not as a definition of the limits of the invention.

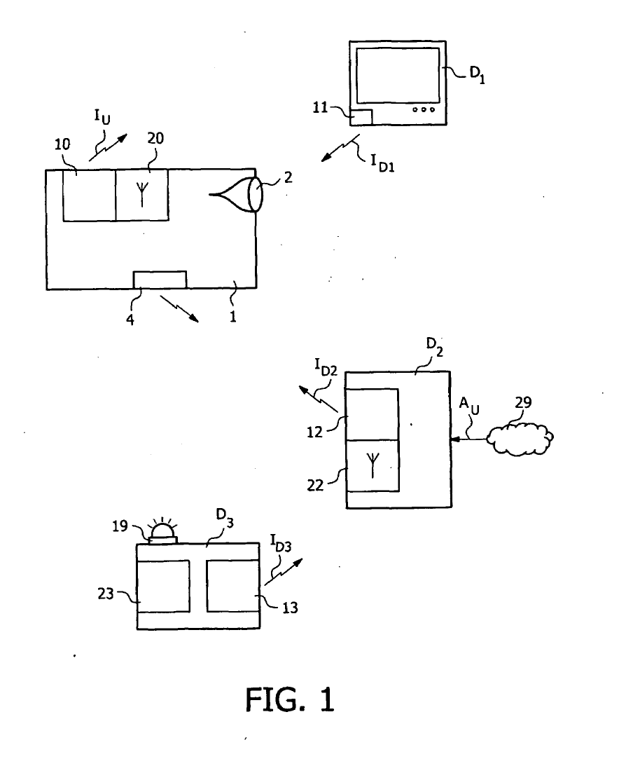

FIG. 1 is a schematic diagram of a pointing device and a number of devices to be controlled in accordance with an embodiment of the present invention;

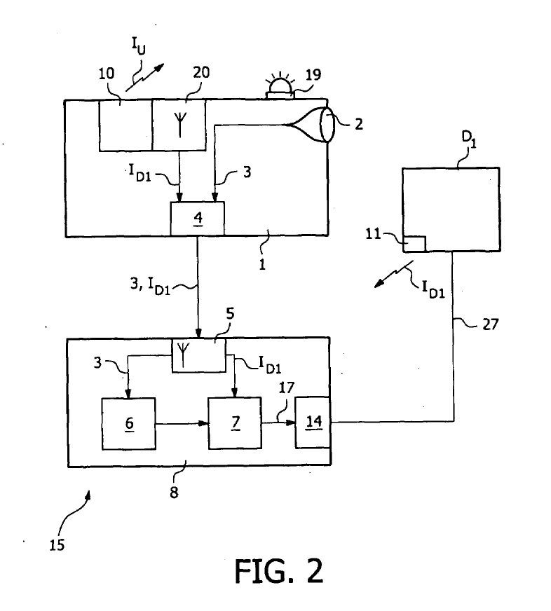

FIG. 2 is a schematic diagram of a system including a pointing device and a device control interface for controlling a device in accordance with an embodiment of the present invention;

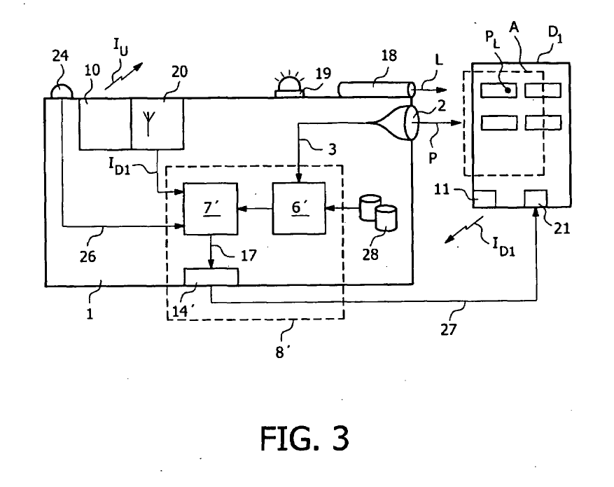

FIG. 3 is a schematic diagram of a pointing device in accordance with an embodiment of the present invention;

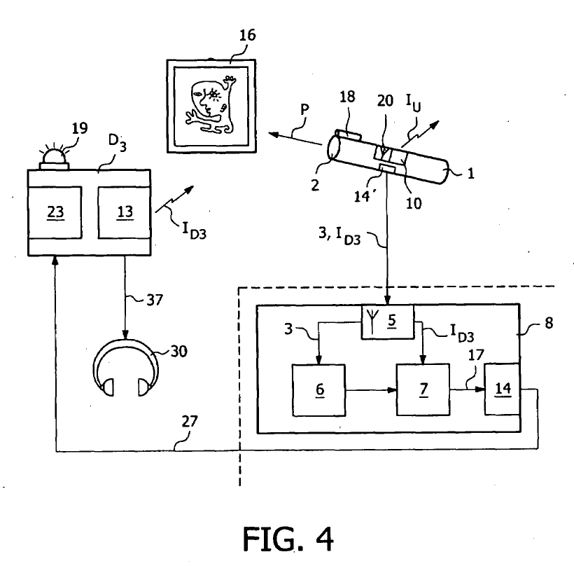

FIG. 4 is a schematic diagram of a system for controlling a device in accordance with an embodiment of the present invention;

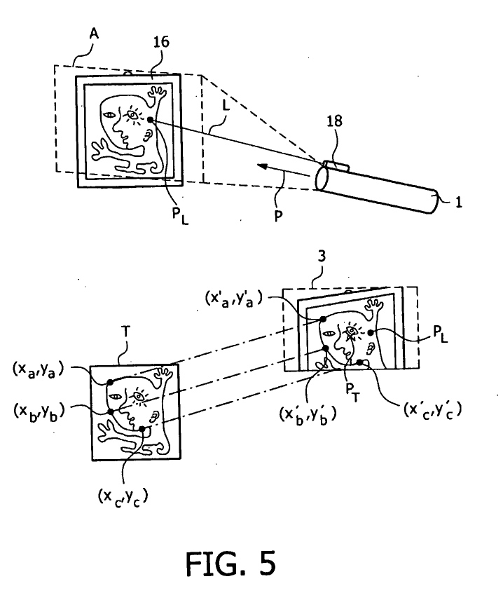

FIG. 5 is a schematic diagram showing an object, its associated template, and a target area image generated by a pointing device in accordance with an embodiment of the present invention.

In the drawings, like numbers refer to like objects throughout. The pointing device described is held and operated by a user, not shown in the drawings.

FIG. 1 shows a number of devices D₁, D₂, D₃, and a pointing device 1 according to an embodiment of the invention. Each of the devices D₁, D₂, D₃ broadcasts its presence by sending device descriptive information I_{D1}, I_{D2}, I_{D3}, for example a radio-frequency identification tag, at regular intervals or intermittently, from an identification module 11, 12, 13. The identification tag I_{D1}, I_{D2}, I_{D3} is detected by a receiver 20 in the pointing device 1.

The pointing device 1 in turn can broadcast user identification information I_{U}, also in the form of a radio-frequency identification tag, from a identification module 10.

In the figure, the device D₁ is a television equipped with an identification module 11 to broadcast its presence by means of an identification tag I_{D1}. Another device D₂, for example a personal computer D₂, is equipped with an identification module 12 for broadcasting device descriptive information I_{D2}, as well as a receiver 22 for detecting user identification information I_{U} broadcast from a pointing device 1. This device D₂ can compare the received user identification information I_{U} with authorization information A_{U} obtained from, for example, an external source 29. The authorization information A_{U} can be a list of authorized and/or prohibited users of the device D₂. On the basis of this information A_{U}, I_{U}, the device D₂ can decide whether or not to allow interaction with the user of the pointing device 1.

A third device D₃ broadcasts its presence with an identification tag I_{D3} sent by the identification module 13, and also provides feedback information by means of an LED 19 mounted on the device. This LED 19 can blink or flash whenever the identification module 13 broadcasts the identification tag I_{D3}, or whenever a receiver 23 of the device D₃ detects user identification information I_{U}, broadcast from a pointing device 1.

In FIG. 2, the system 15 for controlling a device D₁, here the television from FIG. 1, comprises a pointing device 1, a device control interface 8, as well as the device D₁, which might be only one of a number of devices controllable by the device control interface 8.

The pointing device 1 contains a camera 2 which generates images 3 of the area in front of the pointing device 1 in the direction of pointing P. The pointing device 1 features an elongated form in this embodiment, so that the direction of pointing P lies along the longitudinal axis of the pointing device 1. The camera 2 is positioned towards the front of the pointing device 1 so that images 3 are generated of the area in front of the pointing device 1 at which a user, not shown in the diagram, is aiming.

A receiver 10 of the pointing device 1 detects device descriptive information I_{D1}, e.g. an identification tag, broadcast by an identification module 11 of the device D₁. Detection of the device descriptive information I_{D1} causes a feedback indicator, in this case an LED 25 on the pointing device 1 to flash or blink, indicating to the user, not shown in the diagram, that a device, controllable by this pointing device 1, is located in the vicinity.

The user can then proceed to use the pointing device 1 to select some option or specify some function which is to be carried out. To this end, he aims the pointing device 1 at the device D₁ and indicates his selection by pressing a button 24 on the pointing device 1. Images 3 of the target area in front of the pointing device 1, the device descriptive information I_{D1} as well as any control input information from the button, are transmitted by a sending unit 4 to an external device control interface 8, where they are received by a receiver 5. The images 3 are processed in an image analysis unit 6. The image analysis unit 6 makes use of known image processing techniques to identify, from a number of templates, the template most closely matching the image 3, thus identifying the object or device D₃ being pointed at. A control signal generation unit 7 uses the results of the image analysis, as well as the device descriptive information I_{D1} and any control input information to generate a control signal 17 for the device. An application interface 14 performs any necessary conversion to the control signal 17 before sending it in appropriate form 27 to the device D₁.

The information transferred from the pointing device 1 to the device control interface 8 might be transmitted in a wireless manner, e.g. Bluetooth, 802.11b or mobile telephony standards. If the user carries his pointing device on his person, the pointing device might be connected to the device control interface by means of a cable. The signals sent from the device control interface 8 to the device D₁ might be sent over a cabled interface, or might also, as appropriate, be transmitted in a wireless manner.

The pointing device 1 might continually send images 3 to the device control interface 8, or might cease transmission automatically if it is not moved for a certain length of time. To this end, the pointing device 1 might comprise a motion sensor, not shown in the diagram. Since the pointing device 1 is most likely powered by batteries, also not shown in the diagram, it is expedient to only transmit images 3 to the device control interface when required, for example when the user actually manipulates the control input 24, e.g. in the form of a button, in order to prolong the lifetime of the batteries. Transmission of image data 3 might be initiated as soon as the user manipulates the control input 24 in some way, and might automatically cease thereafter.

FIG. 3 shows an alternative embodiment of the pointing device 1, featuring its own image analysis unit 6′ and control signal generator unit 7′ in its own local device control interface 8′. This pointing device 1 can analyse image data 3, device descriptive information I_{D1}, I_{D2}, I_{D3}, and control input information 26, to locally generate control signals 17 for the appropriate device D₁, D₂, D₃.

In this figure, the pointing device 1 is being aimed at an object D₁, in this case the screen of the television D₁. A concentrated beam of light L issues from a source 18 of laser light, and a laser point PL appears within the target area A, which might encompass a part or all of the television screen. After aiming at the desired part of the screen in order to select one of a number of menu options being displayed, the user can press a control input button 24 to indicate his selection. It is not necessary for the entire object D₁ to appear within the target area A, as part of the object D₁ suffices for identification. The target area images 3 are analysed in the image analysis unit 6′ to identify the option which the user has selected, and the results of the image analysis are used by the control signal generator 7′, along with the device descriptive information I_{D1} broadcast by the television D₁, to give appropriate control signals 17 for the television D₁.

The control signals 17 undergo any necessary conversion into a form understandable by the television D₁ before being transmitted to the television D₁ by the application interface 14′. For ease of use, the application interface 14′ communicates in a wireless manner with the television D₁, which is equipped with an appropriate receiver 21 for receiving signals from the pointing device 1. The image analysis unit 6′, control signal generator 7′ and application interface 14′ are part of a local device control interface 8′, incorporated in the pointing device 1.

As illustrated in FIG. 3, being able to perform the image processing locally means the pointing device 1 does not necessarily need to communicate with a separate device control interface 8 as described in FIG. 2. Since the quality of the image analysis might be limited by the physical dimensions of the pointing device 1, which will most likely be realised in a small and practical format, this “stand-alone” embodiment might suffice for situations in which the accuracy of the image analysis is not particularly important, or in situations where the pointing device 1 is unable to communicate with an external device control interface 8.

This embodiment may of course be simply an extension of FIG. 2, so that the pointing device 1, in addition to the local device control interface 8′, also avails of the communication interfaces 4, 5 described in FIG. 2, allowing it to operate in conjunction with an external device control interface, such as a home dialog system, in addition to its stand-alone functionality. This embodiment might also feature a local memory 28 in which the pointing device 1 can store images generated by the camera 2. By means of a suitable interface, not shown in the diagram, the pointing device 1 might be able to load templates obtained from an external source, such as a memory stick, the internet, an external device control interface etc., into the local memory 28.

The identification modules used to broadcast identification tags need not be physically attached to the device being controlled or to the object associated with the device. FIG. 4 shows an example of a realisation where the identification module is separate from the object at which the user aims the pointing device 1. In a museum or gallery setting, for example, information about an exhibit is usually limited, by reasons of space, to the title of the exhibit and the name of the artist, often only in one language. Since a visitor to the gallery might want to learn more about the paintings on display, the gallery in this example supplies each visitor with a pointing device 1 with which the visitor can point at items of interest, and a set of headphones 30 for listening to tutorial or narrative information about the exhibits.

An identification module 13 is incorporated in or attached to device D₃ located beside a painting 16, which is an object associated with the device D₃. Such an identification module 13 could also be incorporated in the object, the design of the object permitting. This identification module 13 broadcasts an identification tag I_{D3} at regular intervals. A receiver 23 receives any user identification information I_{U} broadcast by any pointing devices held by visitors passing by. A feedback indicator 19, in this case an LED, flashes to indicate to the visitor that he can learn more about this . painting 16.

The visitor can then aim the pointing device 1 at the painting 16. A camera 2 in the pointing device 1 generates images 3 of the painting 16. These images 3, along with the device descriptive information I_{D3}, are sent to the device control interface 8, which might be one of several device control interfaces distributed around the museum or gallery, or might be a single device control interface.

The headphones 30 are driven by the device control interface 8, which may be located in a different room, indicated by the dotted line in the diagram.

The images 3 are analysed in the image analysis unit 6 of the device control interface 8, to identify the painting 16 itself or a particular area of the painting 16 at which the visitor is pointing. The device descriptive information I_{D3} can be used to determine the whereabouts of the visitor in the museum or gallery, so that descriptive information 27 about this painting 16 can be transmitted in a wireless manner to the device D₃, close to where the visitor is standing, and forwarded in the form of an audio signal 37 to the headphones 30. Such a scenario might be practicable in museums with numerous exhibits and large numbers of visitors at any one time.

The visitor can avail of a light source 18, mounted on the pointing device 1, to direct a beam of light at a particular area of the painting 16. The resulting visible point of light, which ensues when the beam of light impinges upon the object 16, will be recorded as part of the generated image 3, and can be used in the image analysis process to identify the point at which the user is aiming the pointing device 1. In this way, the visitor can point out particular parts of the painting 16 about which he would like to learn more. He might indicate a particular part of the painting by aiming the pointing device 1 and pressing a button, not shown in the diagram. This control input information, processed along with the images 3 and the device descriptive information I_{D3}, might allow the user to listen to more detailed information over the headphones 30.

The user will not always aim the pointing device 1 at an object from directly in front—it is more likely that the pointing device 1 will be aimed at a more or less oblique angle to the object, since it is often more convenient to aim the pointing device 1 than it is to change one's own position. This is illustrated in FIG. 5, which shows a schematic representation of a target area image 3 generated by a pointing device 1, aimed at the object 16 from a distance and at an oblique angle, so that the scale and perspective of the object 16 in the target area A, in this case a painting in a gallery or museum, appear distorted in the target area image 3.

Regardless of the angle of the pointing device 1 with respect to the object 16, the target area image 3 is always centred around a target point P_{T}. A point of light P_{L} (which appears on the object 16 when a beam of light L, issuing from a light source 18, impinges on the object 16) also appears in the target area image 3, and may be a distance removed from the target point P_{T}, or might coincide with the target point P_{T}. The image processing unit of the device control interface compares the target area image 3 with pre-defined templates T to determine the object 16 being pointed at by the user.

To this end, the point of intersection P_{T} of the longitudinal axis of the pointing device 1 with the object 16 is located in the target area image 3. The point in the template T corresponding to the point of intersection P_{T} can then be located.

Computer vision algorithms using edge- and corner detection methods are applied to locate points [(xₐ′, yₐ′), (x_{b}′, y_{b}′), (x_{c}′, y_{c}′)] in the target area image 3 which correspond to points [(xₐ, yₐ), (x_{b}, y_{b}), (x_{c}, y_{c})] in the template T of the object 16.

Each point can be expressed as a vector e.g. the point (xₐ, yₐ) can be expressed as v̅ₐ. As a next step, a transformation function T_{λ} is developed to map the target area image 3 to the template T:

$$f ( λ ) = {\sum }_{i} {\vert {T}_{λ} ( {\vec{v}}_{i} ) - {\vec{v}}_{i}^{′} \vert}^{2}$$

where the vector v̅ᵢ represents the coordinate pair (xᵢ, yᵢ) in the template T, and the vector v̅′ᵢ represents the corresponding coordinate pair (x′ᵢ, y′ᵢ) in the target area image 3 The parameter set λ, comprising parameters for rotation and translation of the image yielding the most cost-effective solution to the function, can be applied to determine the position and orientation of the pointing device 1 with respect to the object 16. The computer vision algorithms make use of the fact that the camera 2 within the pointing device 1 is fixed and “looking” in the direction of the pointing gesture. The next step is to calculate the point of intersection P_{T} of the longitudinal axis of the pointing device 1 in the direction of pointing P with the object 16. This point may be taken to be the centre of the target area image 3. Once the coordinates of the point of intersection have been calculated, it is a simple matter to locate this point in the template T.

Although the present invention has been disclosed in the form of preferred embodiments and variations thereon, it will be understood that numerous additional modifications and variations could be made thereto without departing from the scope of the invention. The pointing device can serve as the universal user interface device in the home or any other environment with electrically or electronically controllable devices. In short, it can be beneficial wherever the user can express an intention by pointing. Its small form factor and its convenient and intuitive pointing modality can elevate such a simple pointing device to a powerful universal remote control. As an alternative to the pen shape, the pointing device could for example also be a personal digital assistant (PDA) with a built-in camera, or a mobile phone with a built-in camera.

For the sake of clarity, it is also to be understood that the use of “a” or “an” throughout this application does not exclude a plurality, and “comprising” does not exclude other steps or elements. A “unit” may comprise a number of blocks or devices, unless explicitly described as a single entity.

1. A method for control of a device (D₁, D₂, D₃), which method comprises the following process steps:
aiming a pointing device (1) comprising a camera (2) at an object associated with the device (D₁, D₂, D₃) to be controlled to choose an option;
generating an image (3) of a target area (A) aimed at by the pointing device (1);
interpreting the target area image (3) to determine the chosen option, and generating a corresponding control signal (4) for controlling the device (D₁, D₂, D₃) to be controlled, whereby device descriptive information (I_{D1}, I_{D2}, I_{D3}) associated with the device (D₁, D₂, D₃) to be controlled is detected before or during this process, and the process steps are carried out according to the device descriptive information (I_{D1}, I_{D2}, I_{D3})

2. A method according to claim 1, wherein user identification information (I_{U}) is sent from the pointing device (1) to the device (D₁, D₂, D₃) to be controlled.

3. A method according to claim 1, wherein the device descriptive information (I_{D1}, I_{D2}, I_{D3}) for the device (D₁, D₂, D₃) to be controlled is broadcast as an identification tag (I_{D1}, I_{D2}, I_{D3}) by an identification module (11, 12, 13) associated with the device (D₁, D₂, D₃) to be controlled.

4. A method according to claim 1, wherein the user identification information (Iᵤ) for the pointing device (1) is broadcast as an identification tag (Iᵤ) by an identification module (10) of the pointing device (1).

5. A method according to claim 1, wherein authorization information (Aᵤ) for the pointing device (1) is obtained by the device (D₁, D₂, D₃) to be controlled.

6. A method according to claim 1, where the proximity of a pointing device (1) to a device (D₁, D₂, D₃) to be controlled is indicated by a feedback indicator (19) to the user of the pointing device (1).

7. A system (15) for controlling a device (D₁, D₂, D₃) comprising
a pointing device (1) with a camera (2) for generating images (3) of a target area (A) in the direction (P) in which the pointing device (1) is aimed;
a receiving unit (20) for detecting device descriptive information (I_{D1}, I_{D1}, I_{D3}) broadcast by the device (D₁, D₂, D₃) to be controlled;
an image analysis unit (6, 6′) for analysing the images (3);
a control signal generation unit (7, 7′) for generating a control signal (17) for the device (D₁, D₂, D₃) to be controlled according to the results of the image analysis;
and an application interface (14, 14′) for communicating the control signal (17) to the device (D₁, D₂, D₃) to be controlled, whereby the system is composed in such a manner that the image generation and/or image analysis and/or control signal generation and/or signal communication are carried out according to the device descriptive information (I_{D1}, I_{D2}, I_{D3}) of the device (D₁, D₂, D₃) to be controlled.

8. A system (15) according to claim 7 comprising a feedback indicator (19) for indicating the proximity of a device (D₁, D₂, D₃) to be controlled to a pointing device (1).

9. A pointing device (1) for a system according to claim 7, comprising a camera (2) for generating images (3) of a target area (A) in the direction (P) in which the pointing device (1) is aimed, and a receiving unit (20) for detecting device descriptive information (I_{D1}, I_{D2}, I_{D3}) broadcast by the device (D₁, D₂, D₃) to be controlled.

10. A pointing device (1) according to claim 9, comprising a device control interface (8′) for interacting with a device (D₁, D₂, D₃) to be controlled, which device control (8′) interface comprises
an image analysis unit (6′) for analysing the images (3),
a control signal generation unit (7′) for generating a control signal (17) for the device (D₁, D₂, D₃) to be controlled according to the results of the image analysis,
and an application interface (14′) for communicating the control signal (17) to the device (D₁, D₂, D₃) to be controlled.

11. A pointing device according to claim 9 comprising a communication interface (4) for transferring images (3) and, optionally, device descriptive information (I_{D1}, I_{D2}, I_{D3}) for the device (D₁, D₂, D₃) to be controlled to an external device control interface (8) which generates a control signal (17) for the device (D₁, D₂, D₃) to be controlled based on the image and/or device descriptive information (I_{D1}, I_{D2}, I_{D3})

12. A device control interface (8) for a system according to claim 7 for interacting with a device (D₁, D₂, D₃) to be controlled, comprising
a receiving unit (5) for receiving from a pointing device (1) images (3) and, optionally, device descriptive information (I_{D1}, I_{D2}, I_{D3}) for the device (D₁, D₂, D₃) to be controlled;
an image analysis unit (6) for analysing the images (3);
a control signal generation unit (7) for generating a control signal (17) for the device (D₁, D₂, D₃) to be controlled according to the results of the image analysis and, optionally, the device descriptive information (I_{D1}, I_{D2}, I_{D3}) of the device to be controlled (D₁, D₂, D₃);
and an application interface (14) for communicating the control signal (17) to the device (D₁, D₂, D₃) to be controlled.

13. An electrically or electronically controllable device (D₁, D₂, D₃) comprising a device control interface (8) according to claim 12.
